(19) United States
(12) Patent Application Publication
(10) Pub. No.: US 2023/0004688 A1
(43) Pub. Date: Jan. 5, 2023

(54) AUTOMATIC OFFICE SPACE LAYOUT

(71) Applicant: WeWork Companies LLC, New York, NY (US)

(72) Inventors: Haixun Wang, Palo Alto, CA (US); Andrew Heumann, Brooklyn, NY (US); Daniel Davis, New York, NY (US)

(21) Appl. No.: 17/703,550

(22) Filed: Mar. 24, 2022

Related U.S. Application Data
(63) Continuation of application No. 16/835,012, filed on Mar. 30, 2020, now abandoned.
(60) Provisional application No. 62/870,630, filed on Jul. 3, 2019.
(60) Provisional application No. 62/827,061, filed on Mar. 30, 2019.

(51) Int. Cl. G06F 30/13; G06F 30/12

(52) U.S. Cl. CPC G06F 30/13; G06F 30/12; G06F 2111/04

(57) ABSTRACT

A space layout system performs various automated layout techniques to generate space layouts for office and other workspaces. The system can access building information modeling (BIM) information fora space, and automatically determine a layout of desks or other furniture for the space. The system can also provide to receive user input and automatically modify or reconfigure the layout of the space using the automated techniques.

### CROSS-REFERENCE TO RELATED APPLICATIONS

This application is a continuation of U.S. patent application Ser. No. 16/835,012, filed Mar. 30, 2020, entitled AUTOMATIC OFFICE SPACE LAYOUT, which claims priority to U.S. Provisional Patent Application No. 62/827,061, filed on Mar. 30, 2019, entitled AUTOMATIC OFFICE SPACE LAYOUT, and to U.S. Provisional Patent Application No. 62/870,630, filed on Jun. 3, 2019, entitled AUTOMATIC OFFICE SPACE LAYOUT, all of which are incorporated by reference in their entireties.

### BACKGROUND

Space layout is the task of determining how walls, fixtures, furniture, and other features will be placed within space in a building, such as space intended to function as an office. Such space layout is typically performed manually by highly-trained architects. However, when many spaces are to be configured, or spaced are re-configured often, utilizing manual processes can be inefficient and possibly unfeasible, among other drawbacks.

### BRIEF DESCRIPTION OF THE DRAWINGS

FIG. 1 is a partial schematic, partial block diagram of a coworking space.

FIG. 2 are diagrams illustrating floor plans outfitted with similar, but not quite identical offices.

FIG. 3 is a flow diagram illustrating a method for determining a space layout for a space.

FIG. 4A are diagrams illustrating a rotational layout technique to perform layout in a sample space.

FIG. 4B is a diagram illustrating a chair containing a desk clearance zone.

FIG. 5 is a diagram illustrating a left right layout technique.

FIG. 6 are diagrams illustrating results of relaxing alignment rules using the left right layout technique.

FIG. 7 is a diagram illustrating results produced by the brute force layout technique.

FIG. 8 is a diagram illustrating an example layout of an office space.

FIG. 9 is a graph comparing performance of automatic layout versus manual layout.

FIG. 10 is a graph comparing performance of automatic layout using relaxed design standards versus manual layout.

FIG. 11 is a graph showing office capacity results for different layout techniques.

FIG. 12 is a graph showing a relative performance of different layout techniques.

FIG. 13 is a flow diagram illustrating a method for adjusting an automatic space layout for a space based on receiving user input.

FIG. 14A is a screenshot of a layout selection interface, showing a key plan locating the room.

FIG. 14B is a screenshot of the layout selection interface, showing an example of a user interface (UI) displaying user-defined polygonal regions into which offices may be inserted.

FIG. 15 is a screenshot of the UI of FIG. 14, showing an example of a highlight previewing location of a partition to be inserted to a space.

FIG. 16 is a screenshot of the UI of FIG. 14, showing an example of a zone subdivided with inserted partitions.

FIG. 17A is a screenshot of the UI of FIG. 14, showing an example of existing offices that may be further subdivided before insertion of a new partition.

FIG. 17B is a screenshot of the UI of FIG. 14, showing an example of existing offices further subdivided after insertion of a new partition.

FIG. 17C is a screenshot of the UI of FIG. 14, showing an example of how a user can hover over any populated office and obtain real-time feedback displaying the desk count of each option.

FIG. 18 is a block diagram showing some of the components typically incorporated in at least some of the computer systems and other devices on which the system operates.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Conventional approaches to space layout often rely on the labors of human architects, with various disadvantages. For example, architects competent for this task are a scarce human resource, which means that often a significant period of time passes before an architect becomes available to begin a particular project. Further, once a project begins, the project can take days, weeks, or even months to complete. Additionally, the scarcity of architects permits them to charge a substantial rate for their work on such projects. However, aspects of space layout projects can begin and complete more quickly, and at lower cost, when automated.

A software and/or hardware system for automatically performing space layout (“the system” or the “space layout system”) is described. As described herein, the space layout system performs as well, or better than, systems employing manual techniques when laying out a space. For example, a comparison of the system against 13,000 actual offices designed by human architects led to the system performing as well as an architect on 77% of offices and achieved a higher capacity in an additional 6% of comparisons, all while following a set of space standards. Additionally, when the system used the space standards the same way as an architect (e.g., a more relaxed interpretation of space standards), the automated layout technique achieved a 97% match rate, meaning that the automated layout technique completed this design task as well as a designer and in a shorter time.

Automation of space layout tasks offers increased cost savings, reliability, and productivity by systematizing repetitive tasks. At the same time, it allows humans to focus on more high-value and complex tasks. Even partial automation allows a greater parallelization of designer tasks. Instead of focusing on one project for a full week, an architect assisted by the space layout system might tackle two or more projects in the same week, thus scaling output without necessarily increasing workload.

The space layout system can also improve the quality of design decisions according to specific metrics, such as the efficiency of desk layouts or other furniture configurations. As discussed herein, automation of layout tasks can also augment human decision-making during design processes. Accordingly, the space layout system makes designers faster and more efficient, enables more cycles of iteration, and improves the overall efficiency of desks per square foot in layouts, among other benefits.

Space planning, such as the layout of desks within offices, is a task that encompasses all of the above complex decision-making activities with varying layers of difficulty. Functional and experiential considerations, building code requirements, and client expectations are all factors that architects weigh as they design the spaces of a building. The space layout system described herein at least partially automates office layout by automatically placing desks in private offices as well or better than human designers.

To do so, in some embodiments, the space layout system performs desk layouts in private offices using various different automated layout techniques, in order to augment the architect's decision-making process and enable a parallelization of tasks. As described herein, the system's ability to layout desks was benchmarked against existing office layouts created by human architects. In various implementations, the system performs space layout of office walls and fixtures, as well as other building typologies beyond offices.

### Examples of a Suitable Environment

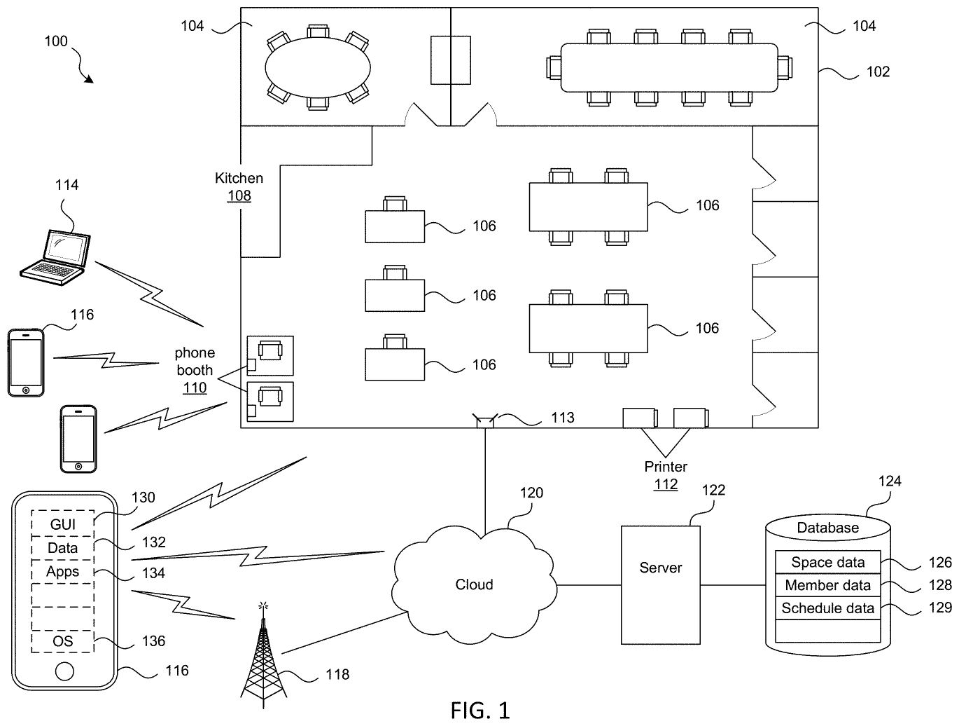

FIG. 1 illustrates an overview of an environment 100 in which some implementations of the disclosed technology can operate. Environment 100 includes a co-working facility 102 or other office space that includes conference rooms 104, desks 106 and a kitchen area 108. The co-working facility also includes additional resources such as phone booths 110 and printers 112, as well as IT infrastructures such as wireless routers 113 to provide wireless local networking (e.g. IEEE 802.11 WiFi networking), networked or “smart” thermostats, smart lighting, and so forth. Further, the facility can include multiple rooms, such as office spaces, open-plan workspaces, small offices, and so on.

Members who use the co-working facility 102 typically have one or more laptop computers 114, mobile phones 116, and other data processing devices that can connect to one or more servers 122 via the wireless routers 113 or via WWAN/cellular base stations 118 and via a network or cloud 120. The server 122 is coupled to one or more databases 124. The database 124 stores data such as space data 126, member data 128 and schedule data 129. The space data 126 includes data related to physical layout and resources within the co-working facility 102. The member data 128 includes information regarding members who work within the facility 102, and can include information regarding rental or lease data, personal information, preferences, and so forth. The schedule data 129 includes information regarding scheduling of resources within the facility 102, such as the conference rooms 104, desks 106, and so forth.

As described below, each member can access or schedule resources within the facility 102 or elsewhere via one or more applications running on the laptop 114 or mobile device 116. As shown, the mobile device can include an operating system 136, one or more applications 134, application data 132 and a graphical user interface (GUI) 130.

While server 122 is displayed logically as a single server 122, the system can employ a distributed computing environment encompassing multiple computing devices located at the same or at geographically disparate physical locations. In some implementations, each server 122 can correspond to a group of servers.

Network or cloud 120 can be any network, ranging from a wired or wireless local area network (LAN), to a wired or wireless wide area network (WAN), to the Internet or some other public or private network. While the connections between the server 122 and the cloud 120 and database 124 are shown as separate connections, these connections can be any kind of local, wide area, wired, or wireless network, public or private.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

### Examples of Automatic Space Layout Techniques

As described herein, arranging desks in office spaces, such as co-working spaces, typically involves navigating the dual objectives of creating a satisfactory experience for the people using the office and achieving optimal revenue or efficiency. Designers want to maximize the number of desks in a space while adhering to a set of space standards that include minimum space requirements per desk, in order to provide a space that is comfortable and safe. Here, a measure of a layout's performance can be referred to as its “efficiency,” which in some embodiments refers to the ratio between desk count and area of the office.

Desk layouts are performed manually by architects, using tacit knowledge of what makes a space efficient. For example, designers typically orient desks along the principal axis of a room to maximize circulation space, but they also intuitively recognize when the room's shape or doorways inhibit such a layout strategy. This process can be time-consuming and tedious as it involves the planning of similar, but not quite identical, offices that follow a consistent design logic.

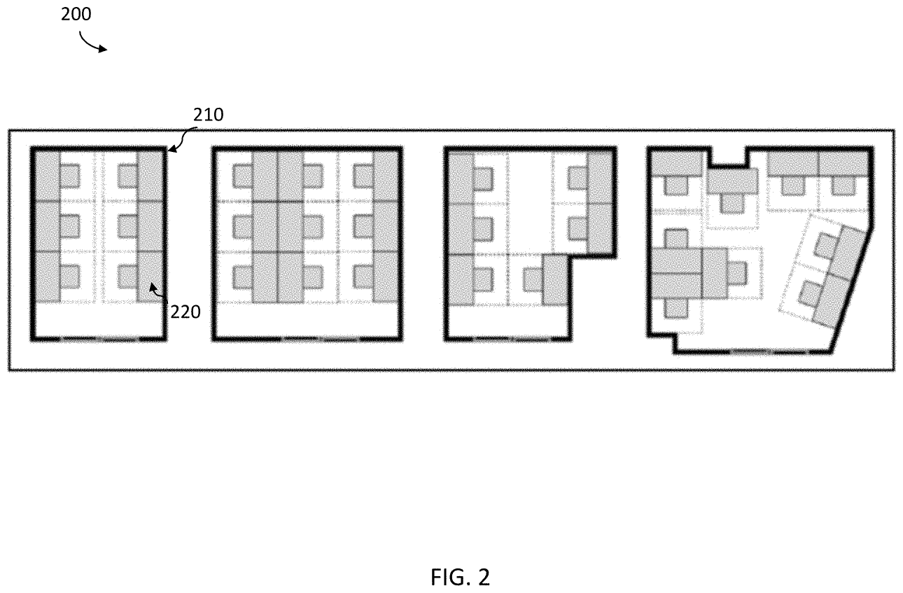

For example, each office has its own set of unique constraints such as room shape, door location, and columns; a cookie-cutter strategy tends not work to in this situation. The space layout system performs techniques to model such design logic. FIG. 2 depicts digital floorplans 200 outfitted with similar, but not quite identical offices.

As depicted, each of the floorplans 200 have different shapes or geometries, as well as different sizes. Thus, a boundary 210 of one floorplan is rectangular, while another is a polygon with various different sized walls meeting at different and irregular angles. Each of the floorplans 200 also depict desks 220 positioned within the boundaries 210. The space layout system, as described herein, performs automatic layout techniques for positioning desks 220 (or other furniture elements, such as chairs, tables, and so on) within the boundaries 210 of the floorplans 200.

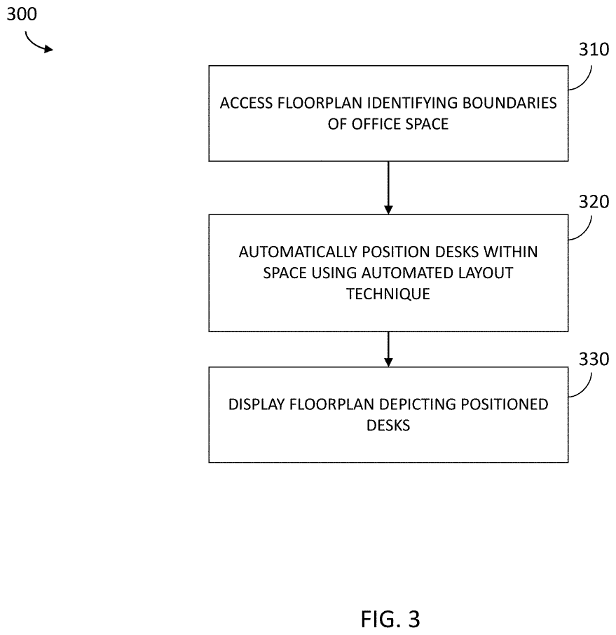

Thus, in some embodiments, the space layout system employs various automatic layout techniques when determining a suitable layout of desks for a workspace, office space, or other similar space. FIG. 3 is a flow diagram illustrating a method 300 for determining a space layout for a space. The method 300 may be performed by the space layout system and, accordingly, is described herein merely by way of reference thereto. It will be appreciated that the method 300 may be performed on any suitable hardware.

In operation 310, the space layout system accesses a floorplan identifying boundaries of an office space. For example, the space layout system can access floorplan information from building information modeling (BIM) data or files, which include information associated with digital representations of physical and functional characteristics of places, such as layout information. The BIM data can be part of a Revit BIM package associated with a space, or other. Computer Aided Design (CAD) packages capable of facilitating 3D and/or parametric object-based design of space, such as office spaces.

In operation 320, the space layout system automatically positions multiple furniture elements within a space using a selected layout technique. For example, the space layout system can select one of many different automatic layout techniques based on various characteristics of the office space (e.g., size, shape, geometry, type of space, and so on), various characteristics of the furniture elements (e.g., size, shape, function, and so on). Thus, the system can select a first technique when configured to position rectangular desks in a symmetrical office space, but select a second, different, technique, when the office space has an irregular shape. Further details regarding the automatic layout techniques are described herein.

In operation 330, the space layout system causes a display of a version of the floorplan that depicts the automatically-positioned furniture elements within the office space. For example, the space layout system renders a version of the floorplan that presents desks or other furniture elements positioned within the floor plan (e.g., within the boundaries) of the office space. The space layout system can present the version of the floorplan via a user interface (UI) via which an architect or designer models or configures the office space.

As described herein, the space layout system utilizes various different layout techniques when automatically placing furniture elements (or other objects) within a floorplan or other representation of a space. In some embodiments, the system uses an n-stage constructive procedure approach. In some embodiments, the system can use metaheuristics derived from detailed historical data on office layouts. For example, using past patterns and sets of “rules of thumb” for making intelligent decisions at each stage of the layout, the system can in some respects model the thought processes of human designers.

For example, given a boundary polygon of an office, the position of the door(s), and a list of any internal obstacles (such as columns and Americans with Disabilities Act entryway maneuvering clearance zones), some of the automatic layout techniques used by the system lay out desks in a way that maximizes their number while adhering to a design standard.

In some embodiments, the space layout system determines automatic layouts for irregularly shaped offices, difficult edge conditions, and accounts for columns and other obstacles within the space. In some cases, an architect manually begins laying out an office by placing desks along the perimeter of the office facing the walls. Some of the automatic layout techniques used by the system enhance that behavior.

In some embodiments, the space layout system executes several simple, related, and computationally inexpensive layout techniques. Then, when the layout density is below a threshold, the system runs a more complex and computationally expensive brute force approach. The exact layout density threshold is configurable and can be set at a point at which an office is no longer profitable, which can vary based on the company to whose space the system is being applied.

In some embodiments, the brute force approach is roughly two orders of magnitude slower than the other techniques but can still calculate a 20 desk layout in less than a second when running on a consumer laptop, which is a task that would typically take a human designer around 2 minutes. These techniques are also generally parallelizable, so a number of rooms can be solved in parallel and distributed across multiple cores on a machine or on a cluster of instances.

In some cases, the space layout system utilizes a rotational layout technique. Using this technique, the system traverses the edges of an office's perimeter. If the edge is shorter than the width of a desk, the edge is ignored—a constraint relaxed in some other layout techniques used by the system. On the other hand, if the edge is sufficiently long enough to place a desk, the system starts from one end of the edge and lay down as many desks as possible along that edge.

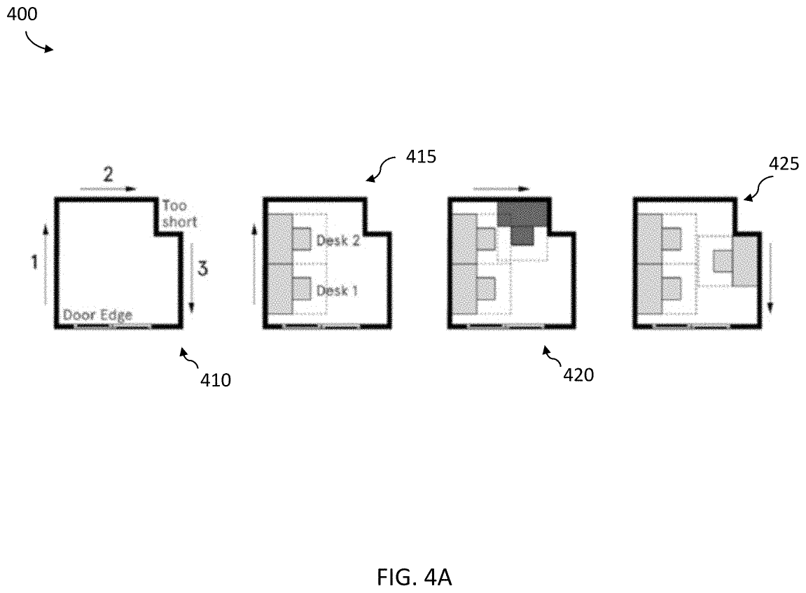

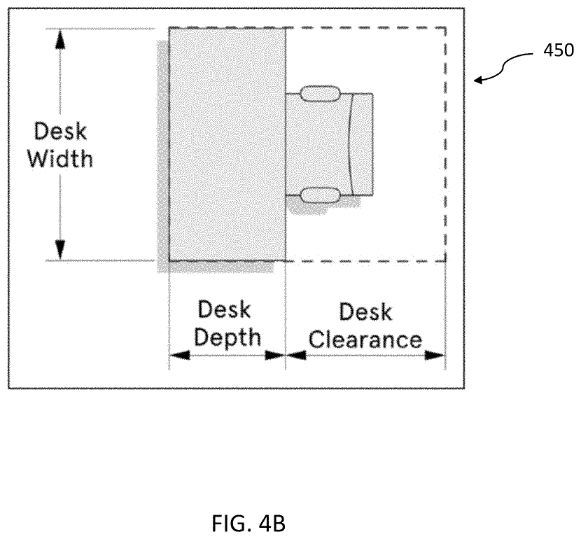

FIG. 4A depicts the system's use of a rotational layout technique to perform layout in a sample space. The system generates a layout for three people. In some embodiments, the system performs the rotational layout technique three times, with the only difference being the order in which the edges are traversed, as follows:

(a) clockwise: start from the edge left of the main door and run clockwise along the perimeter;

(b) counterclockwise: start from the edge right of the main door and run counter-clockwise along the perimeter; and

(c) sort by length: sort the edges by length and process them from longest to shortest.

For example, in step 410, the system determines which edges to traverse, and in which order. Next, in step 420, the system, starting from the “bottom” of the first edge, starts adding desks (e.g., Desk 1 and Desk 2). Then, in step 430, the system repeats the steps for all other edges. As shown, the top edge fails, because the desk cannot be positioned and satisfy the desk clearance rule. In step 440, the final desk is positioned within the space.

Thus, as the technique attempts to place desks along the edges, it seeks to satisfy a number of constraints based on a design standard, including:

(a) a minimum distance from the desk to the door;

(b) sufficient space around the chair for a person to get in and out of their chair comfortably, modeled as a desk clearance zone extending from the desk (see zone 450 as depicted in FIG. 4B);

(c) a minimum distance from end of desk to other desks (excepting desks in the same bank of desks), in order to ensure sufficient circulation between groups of desks;

(d) a desk and its clearance zone should not overlap any obstacles; and so on.

When a desk placement fails any of these constraints, the system slides the desk 1 inch (2.5 cm) along the edge and applies the same logic and constraints again.

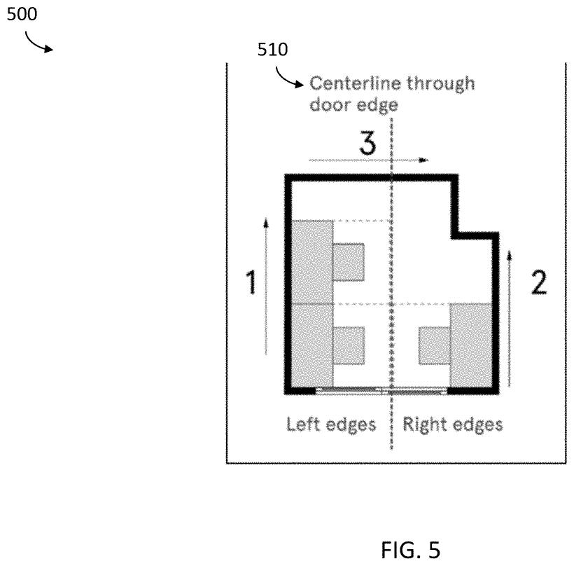

In some cases, the space layout system utilizes a left right layout technique. The left right layout technique is similar to the rotation technique, with a few distinguishing steps. First, the left right technique traverses all the sufficiently long edges to the left of the door edge first, and then the edges to the right of the door, where left and right are determined by taking a line perpendicular to the door edge, running through its center, as depicted via a line 510 of FIG. 5. Also, when laying down desks, the left right technique works from the bottom up so that the resulting layout is more symmetrical, which is often closer to how architects tend to lay out desks.

In some embodiments, the system performs the left right layout technique twice. The first time, the system enforces a constraint that desks should be completely touching the wall and cannot hang off a short wall, such as a mullion. Here, the system ignores any wall that is less than desk width long (as described above). However, many offices have indentations, columns, and other awkward edge conditions resulting in walls less than desk width length.

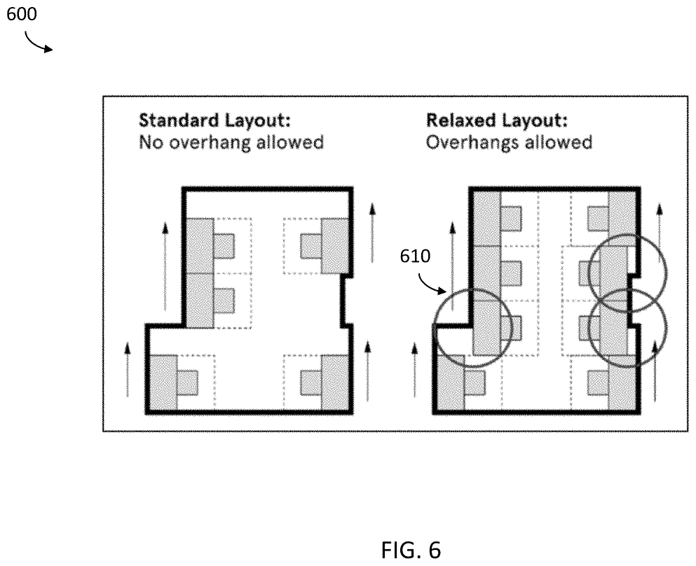

Consequently, the system performs the left right technique a second time when it seeks to lay down desks on all edges, irrespective of their length, and thus desks are permitted to overhang an edge. FIG. 6 depicts a resulting layout 600 of desks when the system ignores these constraints and relaxing alignment rules as part of the left right layout technique.

For example, rather than starting at the bottom of the edge with the desk completely touching the wall, the system starts with just 1.5 feet (46 cm) of desk touching the wall and the system lays down and slides up desks until there is 1.5 feet overlapping. Unlike the standard layout, in which desks may not overhang corners, the layout follows relaxed rules in which desks are positioned at overhang corners 610 by up to 1.5 feet, resulting in greater office capacity—eight desks rather than five desks, as shown in the Figure.

In some embodiments, after the space layout performs each of the layout techniques, it determines the highest capacity found. If the density corresponding to that capacity is below a configurable threshold, the system performs a brute force automatic approach to the layout of the desks. The brute force layout approach or technique is, in some cases, roughly two orders of magnitude more computationally expensive, and so in some embodiments is only run when the above perimeter-based techniques do not sufficiently fill the space.

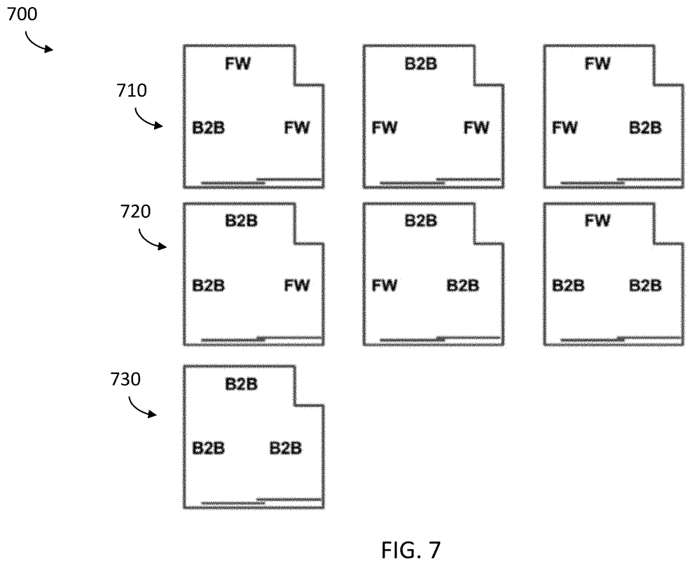

This brute force approach assumes that for each edge, desks are either placed in a line facing the wall (FW) or they exist as a set of back-to-back (B2B) banks of desks extending into the space, as shown in the groupings of desks 700 of FIG. 7. As shown, a first set of layout configurations 710 depicts combinations where one edge includes back-to-back desks, and other edges include facing wall desks. A second set of layout configurations 720 depicts combinations where two edges includes back-to-back desks, and other edges (one or more) include facing wall desks. A final layout configuration 730 depicts all edges having B2B desks.

The space layout system takes a brute force approach to determining which edges should be set as back-to-back within the space. In the absence of obvious heuristics, the system tries all possible combinations with one, two, or three edges designated as back to back, and the remaining edges wall-facing, when performing the brute force approach.

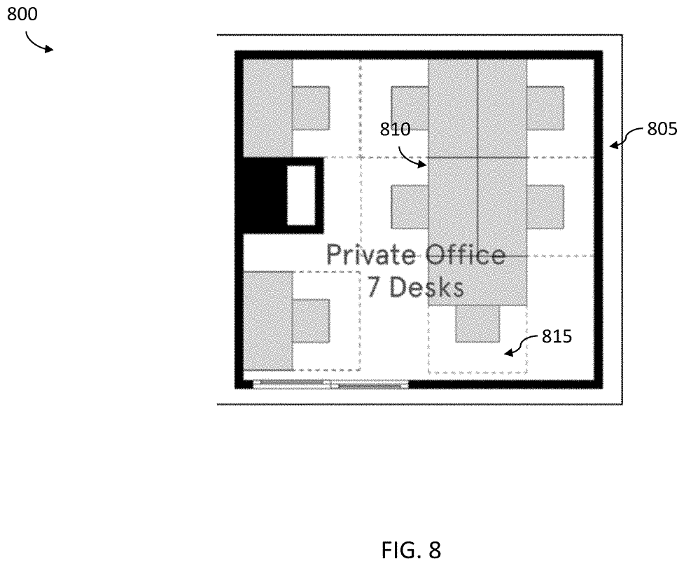

In some embodiments, the system also tries a variant in which, for each edge that is longer than desk width, it considers three options: no desks, face wall, and back to back. The “no desks” option can be useful to allow a bank of desks on other walls to fit within the space. For example, as shown in FIG. 8, the lack of desks on the right and lower walls 805 within a space 800 allows room for a 5-desk bank 810 extending from the top wall, leading to a higher capacity of desks than having desks on the right wall.

In some cases, it follows that having three options per wall can lead to a combinatorial explosion in which the number of combinations of desks to process grows very quickly with the number of walls. Thus, in some cases, the system may employ the brute force approach only when the number of walls longer than the desk width is 4 or less (because while 34=81 is manageable, 35=243 may prove to be inefficient).

Thus, the space layout system can determine whether to run the three-option variant. If so, the system runs that set of layouts both clockwise and anti-clockwise; if not, the system runs the standard two-option variant, both clockwise and counterclockwise.

In some cases, for each of these combinations in the brute force approach, the rotation layout technique is used, either clockwise or counterclockwise, to lay out perimeter desks either facing the wall or setting out back-to-back desks. The system then takes each set of back-to-back desks and attempts to grow them toward the center of the space one layer at a time, following applied layout constraints. In some cases, the system follows additional constraints, such as the number of desks banks (e.g., no more than 5 deep). Also, when a bank of desks cannot be grown any more by desks perpendicular to the edge, the system can attempt to lay down an additional end cap desk, or rotate any existing single end desks to be an end cap, such as desk 815 of FIG. 8.

### Example Space Layouts

As described herein, the space layout system was performed with respect to a sample of 13,211 offices having manually determined layouts. The smallest offices in the sample had space for one person (a single desk), and the largest offices had space for 20 people. All of these offices had been laid out by human designers, and the space layout system was applied to re-layout the offices. The system measured the percentage of offices for which the system was able to match or improve on the efficiency of the design laid out by their human designers.

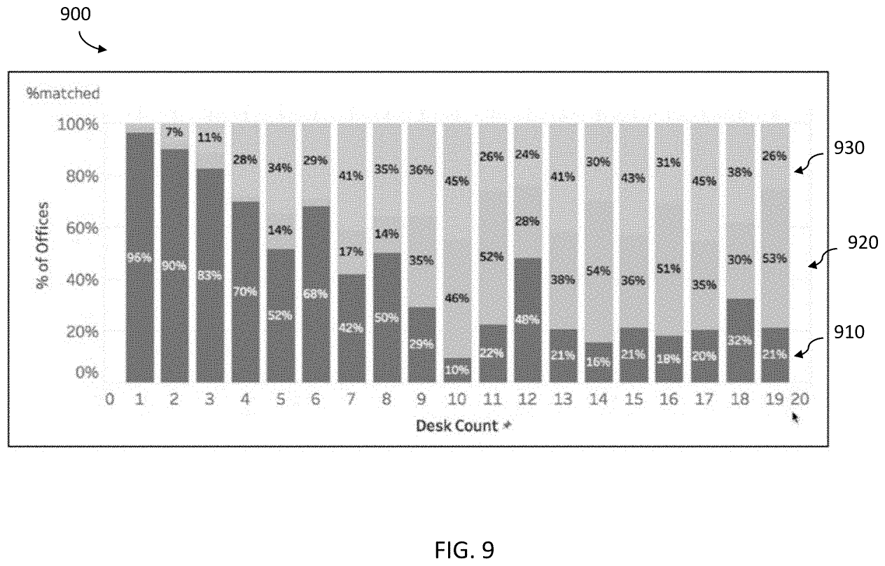

FIG. 9 shows a graph 900 of the initial performance of the system across the sample (when following design standards). The graph 900 shows a percentage 910 of offices where the system matched, a percentage 920 that had higher capacity, and a percentage 930 having lower capacity than human architects against actual office desk count. Overall, the system performed extremely well on 1-4 person offices, producing desk counts that match or exceed those of human designs. Overall, the system matched the efficiency of the architects 77% and achieved a higher efficiency 6% of the time, while following the design standards.

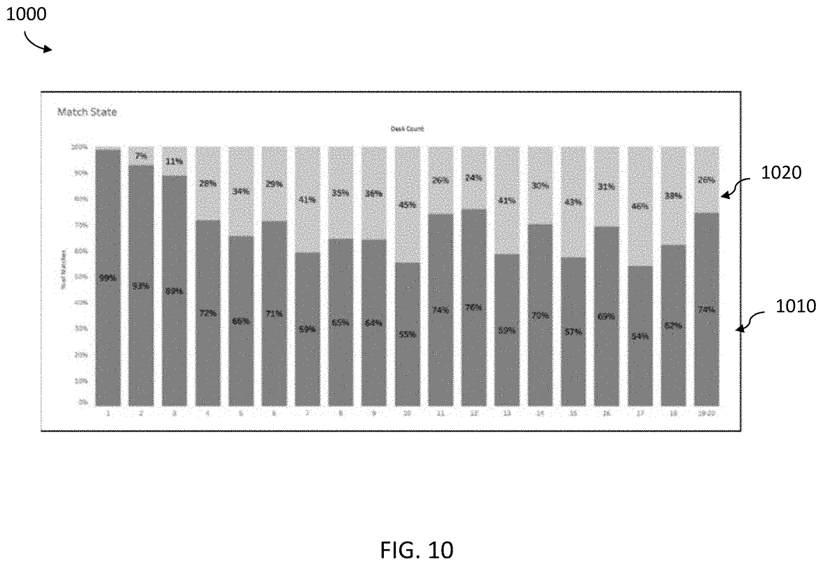

FIG. 10 shows a graph 1000 of the performance of the system using relaxed rules, in which percentages of offices where percentages 1010 when the system matched or had higher capacity than human architects against actual office desk count are the bottom end of the bar, and percentages 1020 of lower capacity than humans are shown at the top end of each bar. Overall, the graph 1000 indicates that the system increases the performance by +12%, with the system only breaking the rules 17% of the time, which is less than the rate at which designers broke the rules. Overall, the system achieved a match rate of 97%, with significant improvements across larger offices.

In some embodiments, the space layout system uses six different layout techniques to layout desks in an office. In order to understand which techniques performed the best across the sample, the system identified the components that had the best efficiency at each run.

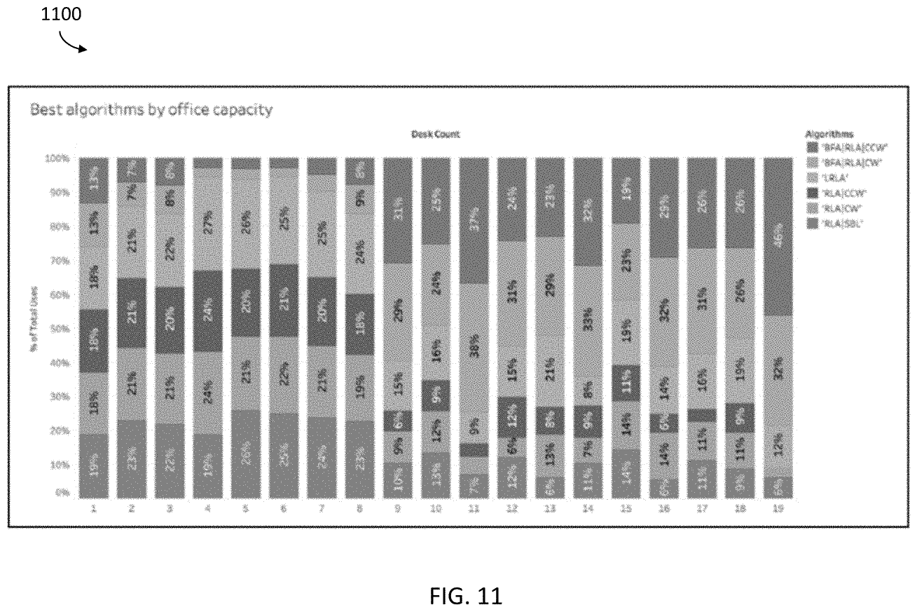

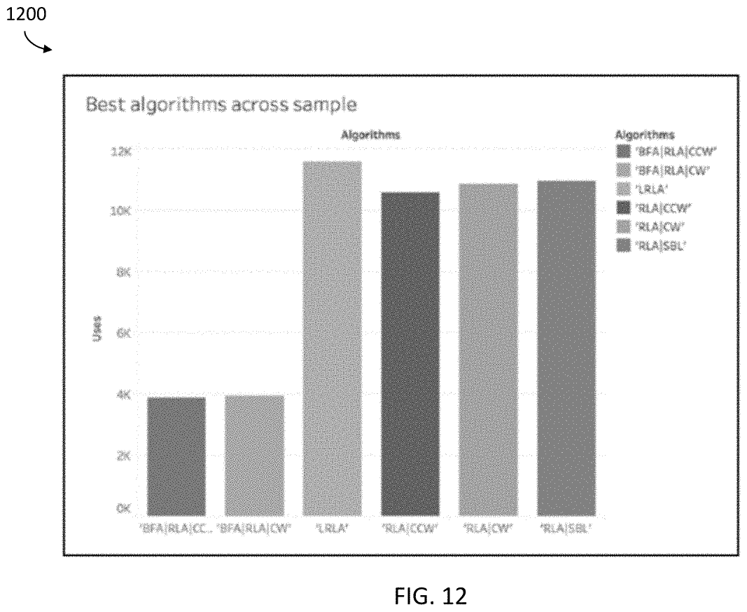

The graph 1100 of FIG. 11 shows the frequency at which each technique had the highest desk count. In FIG. 11, the techniques are labeled as follows: BFA, brute force technique; RLA, rotation layout technique; LRL:A, left right layout technique; SBL, sort by length technique; CW, clockwise technique; and CCW, counterclockwise technique. The left right layout technique performed the best, especially on small (1-8 person) offices. The graph 1200 of FIG. 12 depicts how the techniques performed over various office sizes. For example, the two variations of the brute force technique perform best on 8+ person offices.

Thus, as described herein, the space layout system can select automatic layout techniques based on a variety of characteristics, such as space geometry, space, size, number of people for the space, number of desks, and so on.

### Examples of Implementing the Space Layout System

As described herein, the space layout system is designed to be accessible to architects and designers, and seamlessly integrated into existing workflows. Therefore, the space layout system can facilitate or be part of a variety of layout or design programs or packages, including computer aided design (CAD), Autodesk (including Revit BIM packages), and so on.

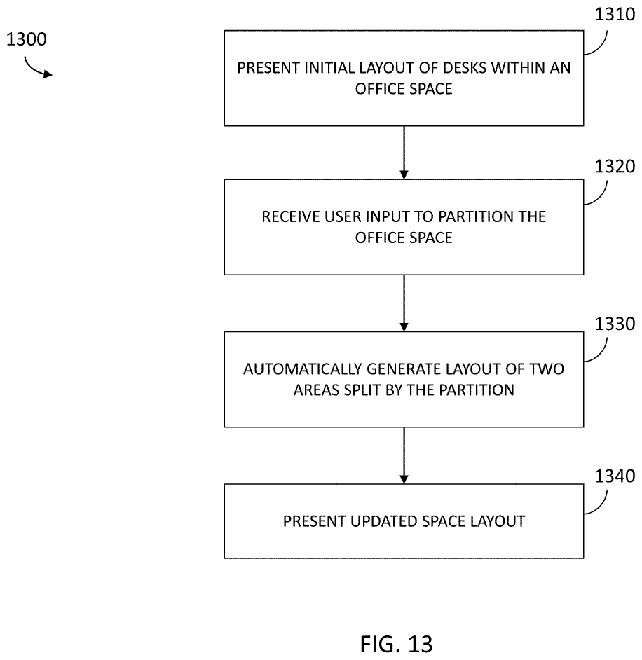

In some embodiments, the space layout system employs the layout techniques before or after receiving input from a designer or user, such as when the designer is viewing or modifying an initial or existing layout via a user interface of the system. FIG. 13 is a flow diagram illustrating a method 1300 for adjusting the space layout for a space based on receiving user input. The method 1300 may be performed by the space layout system and, accordingly, is described herein merely by way of reference thereto. It will be appreciated that the method 1300 may be performed on any suitable hardware.

In operation 1310, the space layout system presents, via a user interface of the space layout system, an initial space layout of desks within a digital floorplan of the office space. For example, the space layout system can generate an initial or first layout for the office space using one or more automatic layout techniques described herein.

In operation 1320, the space layout system receives user input that indicates an addition of a partition to the digital floorplan. For example, a user employing the space layout system can insert or add a partition to the floorplan in order to change the floorplan by adding a room, office, wall, and so on. In some cases, the addition of the partition splits the digital floorplan into two separate areas, such as dividing one room into two rooms.

In operation 1330, the space layout system automatically reconfigures or generates a layout of desks within each of the two areas of the digital floorplan using a selected automatic layout technique. For example, the space layout system can employ the various techniques described herein to render new or modified layouts of desks or other furniture elements for the areas of the floorplan newly created by the inserted partition.

In operation 1340, the space layout system presents, via the user interface of the space layout system, an updated space layout of the office space that includes the automatic reconfiguration of the layout of desks within each of the two areas of the digital floorplan. In some cases, the space layout system can insert or render other elements provided by rooms, such as doors, windows, and so on.

Further, the space layout system can automatically update the layout of the areas based on certain parameters or facilitate user-selection of an updated layout. Thus, in some cases, the system automatically generates a number of potential desk layouts within the two areas of the digital floorplan and selects a most or more space efficient desk layout of the potential desk layouts as the updated space layout of the office space. However, in other cases, the system automatically generates a number of potential desk layouts within the two areas of the digital floorplan and presents the generated potential desk layouts via the user interface of the space layout system for selection by a user as the updated space layout of the office space.

Thus, in various embodiments, the space layout system uses a variety of paradigms to inject new, specialist software tools into an existing workflow, including, for example:
In-platform plug-ins that interface directly with the design software's geometry libraries and APIs (e.g., ElumTools);
Stand-alone desktop software with file-based import/export (e.g. MassMotion Flow); and/or
Web-based APIs performing calculation on a server and interacting with a lightweight platform-integrated interface; and so on.

In some embodiments, some or all of the system's layout techniques are implemented in Python, leveraging the Shapely geometry library, and hosted on a server with a REST API served by the Flask web framework. This approach permits interaction with the layout technique from multiple platforms during development and user testing and allows future platform integrations with limited additional effort.

Further, a common design and documentation platform in use by designers is Autodesk Revit, a popular BIM package. In some embodiments, therefore, the system's designer-facing client for the layout API can be implemented as a Revit add-in.

In some embodiments, the client interface to the system allows a user to lay out desks automatically in multiple offices simultaneously and choose from among a number of automatically generated options. In cases where the generated solution is acceptable, no further work is required; however, in practice, a designer may desire to tweak or adjust the resulting layouts. Even in this case, the system is likely to save time by automatically introducing the proper model elements and producing a rough count of the possible desks that the office can support.

In some embodiments, a designer uses the client interface as follows:
1. The designer selects a room or a series of rooms, typically in a two-dimensional (2D) plan view.
2. The designer initiates either the “Desk Automation” command or the “Desk Automation Advanced” command, which enables more detailed specification of solution parameters, like desk sizes and required clearances.
3. For each selected room, the designer is presented with a graphical preview of the unique layouts generated by the system (e.g., via the techniques described herein).

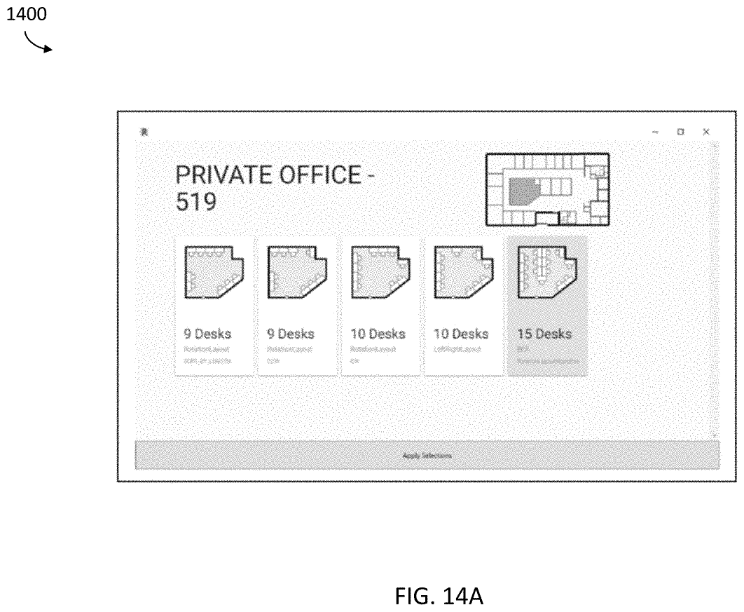

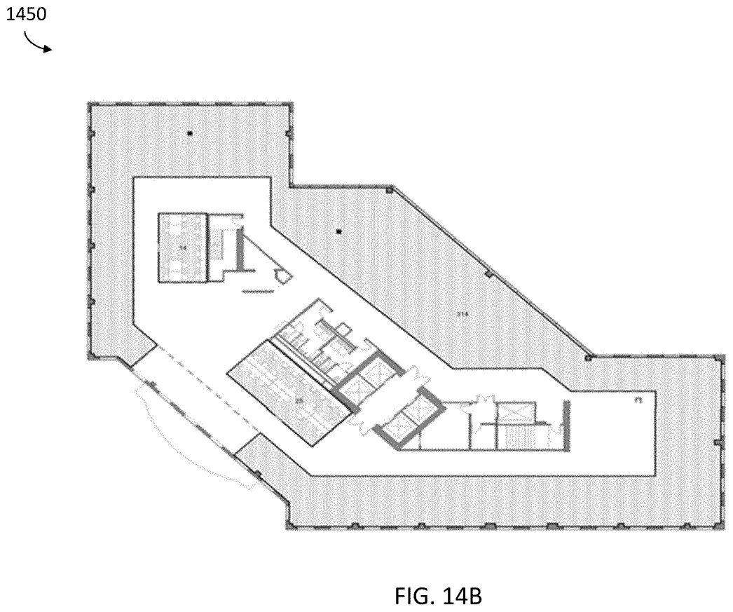

For example, FIG. 14A presents a screenshot 1400 of the layout selection interface, showing a key plan locating the room, and the system's unique layout options for one room, labeled with their desk counts. Using the UI depicted in screenshot 1400, a designer interacts with the system as follows:
4. The designer selects one option for each room and confirms completion.
5. The specified layouts are then implemented in the Revit model: “Family” model elements representing both a desk and a chair are automatically placed according to the positions and orientations returned by the API.
6. If desired, the designer can adjust and finesse the generated layouts as they would any other Revit model content, for example.

Further, in various embodiments, the system provides some or all of the following additional features:
the system can present a number of options to a designer, such as in any case where there is not a single, well-defined optimum;
the system can be transparent about the processes at work, wherever possible, such as by providing and linking to open, human-readable documentation;
the system can enable manual overrides of both input parameters and design outputs;
the system can provide a “lookup” mechanism for recognizing established past best solutions from user input rather than calculating them anew each time;
the system can provide a mechanism to record the history of designer choice from among the provided layout options, allowing the system to evaluate which option is most likely to be selected; and so on.

These features enable provision of ultimate agency and decision-making in the hands of experienced designers, while augmenting their capabilities with faster iteration.

As described herein, the space layout system streamlines the process of laying out offices in a floorplan. A goal is to augment the ability of human architects to quickly test ideas, make decisions, and arrive at design solutions that comply with standards and satisfy programmatic targets. The system can emphasize minimizing interruption to existing, non-linear workflows, and reinforcing designers' own conceptual models of the process.

FIGS. 14B through 17C depict screenshots of a layout selection interface of the system, showing an example of a user interface (UI) displaying user-defined polygonal regions into which offices may be inserted. For example, FIG. 14B is a screenshot 1450 of a user interface of a floor of an office, where different offices or areas can be inserted. As described herein, the designer can interact with the user interface to provide user input, and the system can perform various techniques described herein to present layouts of desks and other furniture elements with the space.

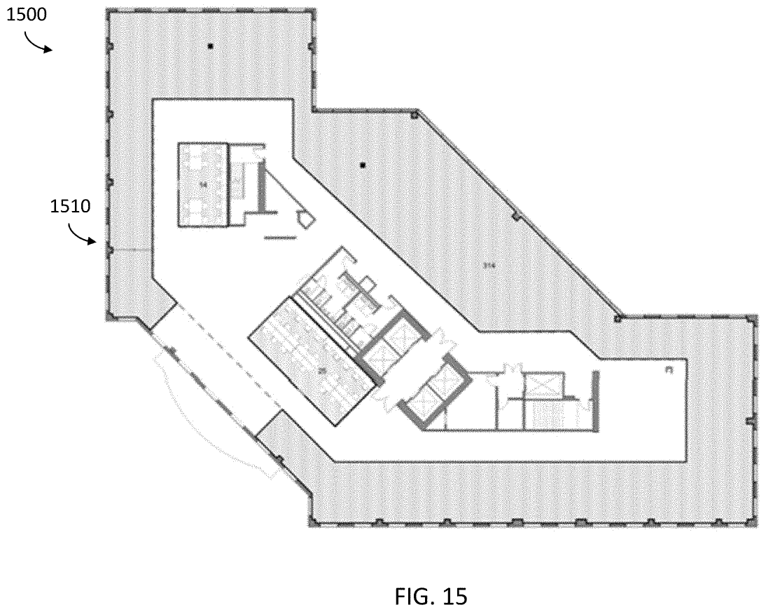

FIG. 15 is a screenshot 1500 depicting an example of highlight previewing a location of a partition 1510 to be inserted, where the partition automatically snaps to perpendicular from a nearest wall upon insertion.

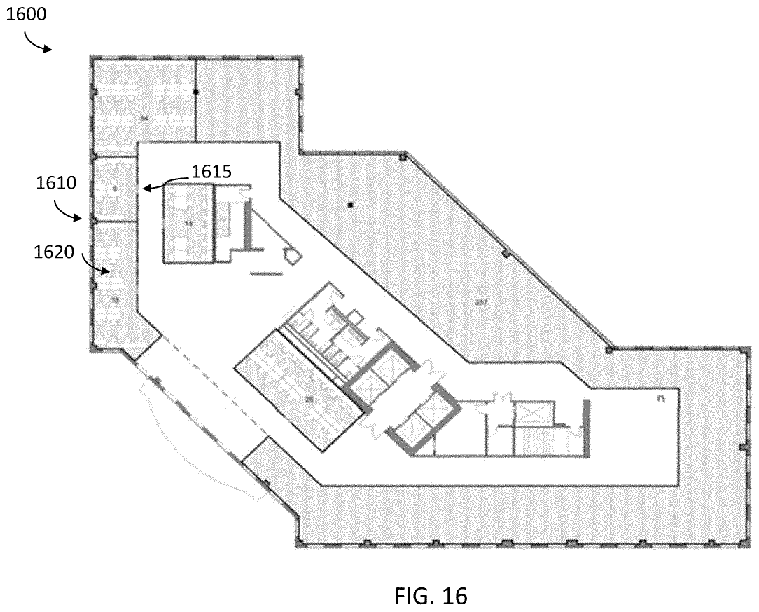

FIG. 16 is a screenshot 1600 depicting an example of a zone being subdivided into areas based on inserted partitions 1610, with door locations 1615 being automatically added and desk layouts 1620 being presented within each office region smaller than a certain size.

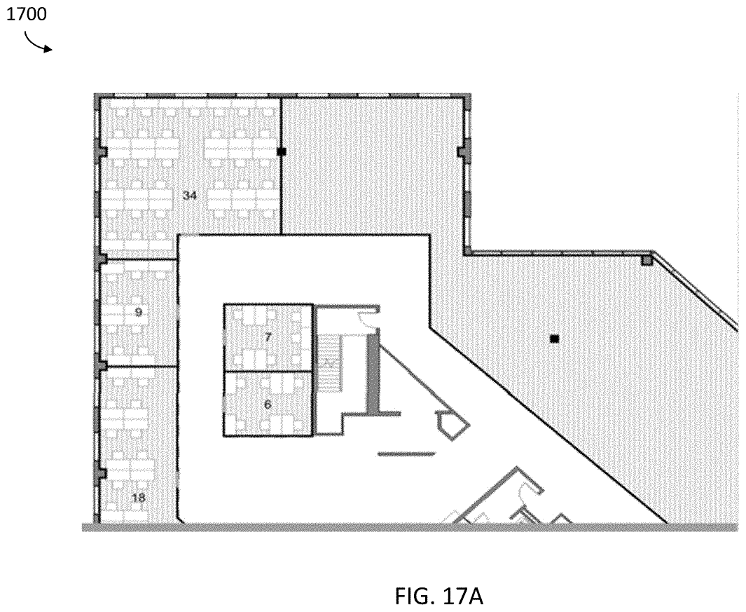

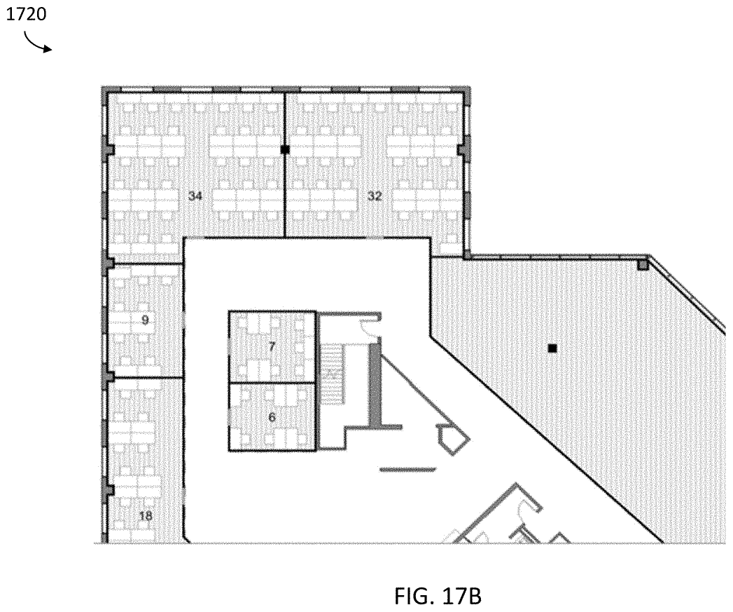

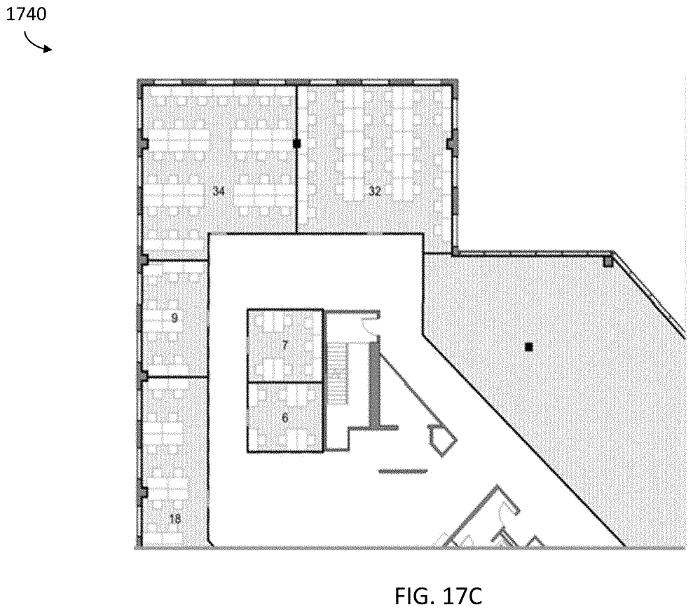

FIG. 17A is a screenshot 1700 depicting an example of existing offices that may be further subdivided before insertion of a new partition. FIG. 17B is a screenshot 1720 of the UI of FIG. 14, showing an example of existing offices further subdivided after insertion of a new partition, while FIG. 17C is a screenshot 1740 where a user can hover over any populated office (here, a newly created office after subdivision) and toggle between multiple potential layout options, with live or real-time feedback displaying the desk count of each option.

A workflow can be as follows: a designer represents an office's zones as polygonal regions in Revit. From this point the space layout system launches a custom interface, and the designer's task is to insert partitions into the previously-defined zones, splitting the zone into individual offices, though in another embodiment discussed below, the system can automatically add or suggest partitions. Moving the cursor shows a preview of the partition's location (FIG. 15), which snaps automatically to a perpendicular from the nearest wall, as well as aligning to any columns or structure, and a single click finalizes the insertion. The system then automatically inserts a door along the boundary, which can be repositioned if necessary. As soon as the partition is inserted, the system generates a number of potential desk layouts within the office polygon, and the most efficient layout is rendered into the plan.

If the desks don't fit as expected, the designer has the ability to go back and drag the walls of the room, with the new layout automatically computing, or to cycle through alternate layouts generated by the algorithm. In this manner, the designer can jump between scales and doesn't have to fix the walls in place before positioning the desks.

In effect, the architect and present system work alongside one another, the architect working at a high level of abstraction, establishing the zoning and partitioning of the office through iterative exploration while the automation algorithm handles the lower-level task of laying out desks in each office, using the techniques described herein.

In other cases, the space layout system can begin to refine zones, provided by an input plan, into individual rooms and spaces, guided by a detailed space program. Special attention is paid to a ‘unit mix’ or breakdown of specific office sizes required; these targets can be tied to business metrics, as different office sizes may sell better or prove more profitable in different regions. Beginning at one end of a zone designated as office, the system can start to place desks in efficient and standards-compliant configurations, and then insert walls or partitions to subdivide the zone into individual private offices.

Depending on how the rooms fit together, the system can iteratively jump back up to adjust the overall zoning or jump down to tweak how individual desks are positioned. In this manner, the system need not follow a linear path but rather cycle between scales until providing a layout that satisfies the constraints.

### CONCLUSION

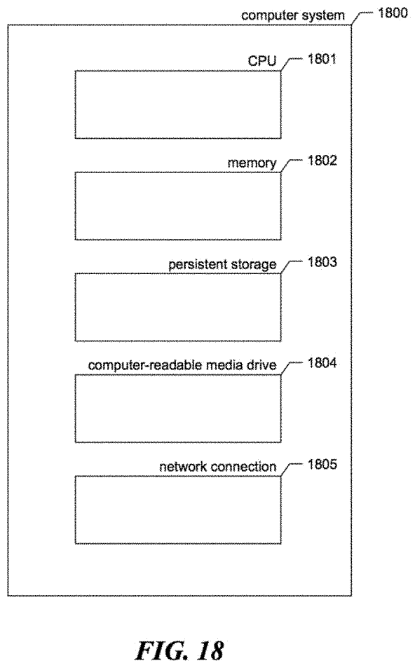

FIG. 18 is a block diagram showing some of the components typically incorporated in at least some of the computer systems and other devices on which the system operates. In various embodiments, these computer systems and other devices 1800 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 1801 for executing computer programs; a computer memory 1802 for storing programs and data while they are being used, including the system and associated data, an operating system including a kernel, and device drivers; a persistent storage device 1803, such as a hard drive or flash drive for persistently storing programs and data; a computer-readable media drive 1804, such as a floppy, CD-ROM, or DVD drive, for reading programs and data stored on a computer-readable medium; and a network connection 1805 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the system, those skilled in the art will appreciate that the system may be implemented using devices of various types and configurations, and having various components.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the following and later claims.

We claim:

1. A computing system that performs automatic space layout for an office space, the system comprising:
one or more software modules stored in memory; and
a processor configured to execute the one or more hardware modules;
wherein the one or more hardware modules include:
an access module that accesses a floorplan identifying boundaries of an office space;
a layout module that automatically positions multiple furniture elements within the accessed floorplan using a selected layout technique,
wherein the multiple furniture elements have predefined dimension; and
a display module that causes a version of the floorplan in which the automatically-positioned furniture elements are depicted to be displayed via a user interface of the computing system.

2. The computing system of claim 1, wherein the layout module automatically positions multiple furniture elements within the accessed floorplan by:
performing a rotation automatic layout technique or a left right automatic layout technique to lay out the multiple furniture elements within the accessed floorplan;
determining whether a desk capacity resulting from the automatically-positioned furniture elements satisfies a minimum threshold capacity for the office space; and
when the determined desk capacity does not satisfy the minimum threshold capacity for the office space, performing a brute force automatic layout technique to lay out the multiple furniture elements within the accessed floorplan.

3. The computing system of claim 1, wherein the access module accesses building information modeling (BIM) data associated with the office space.

4. The computing system of claim 1, wherein the layout technique is selected based on size characteristics of the floorplan of the office space.

5. The computing system of claim 1, wherein the furniture elements include digital representations of desks and chairs positioned within the floorplan of the office space.

6. A method in a computing system for performing automatic layout of an office space, the method comprising:
accessing a floorplan identifying boundaries of an office space;
using a selected layout technique, automatically positioning multiple furniture elements within the floorplan of the office space; and
causing a version of the floorplan in which the automatically-positioned furniture elements are depicted to be displayed or printed.

7. The method of claim 6, further comprising:
receiving user input associated with adjusting a position of a specific automatically positioned furniture element; and
adjusting the position of the specific automatically-positioned furniture element in accordance with the received user input.

8. The method of claim 6, further comprising storing a version of the floorplan incorporating the automatically-positioned furniture elements.

9. The method of claim 6, wherein the automatic positioning specifies a location and rotational position of each positioned furniture element.

10. The method of claim 6, wherein the selected layout technique is a brute force automatic layout technique.

11. The method of claim 6, wherein the selected layout technique is a rotation automatic layout technique.

12. The method of claim 6, wherein the selected layout technique is a left right automatic layout technique.

13. The method of claim 6, wherein the selected layout technique is a sort by length automatic layout technique.

14. The method of claim 6, wherein the selected layout technique is a clockwise automatic layout technique.

15. The method of claim 6, wherein the selected layout technique is a counterclockwise automatic layout technique.

16. A non-transitory computer-readable medium whose contents, when executed by a space layout system, cause the space layout system to perform operations for presenting a space layout for an office space, the operations comprising:
presenting, via a user interface of the space layout system, an initial space layout of desks within a digital floorplan of the office space;
receiving user input that indicates an addition of a partition to the digital floorplan, wherein the addition of the partition splits the digital floorplan into two areas;
automatically reconfiguring a layout of desks within each of the two areas of the digital floorplan using a selected automatic layout technique; and
presenting, via the user interface of the space layout system, an updated space layout of the office space that includes the automatic reconfiguration of the layout of desks within each of the two areas of the digital floorplan.

17. The non-transitory computer-readable medium of claim 16, wherein the updated space layout includes an insertion of a new door element into at least one of the two areas of the digital floorplan.

18. The non-transitory computer-readable medium of claim 16, wherein automatically reconfiguring a layout of desks within each of the two areas of the digital floorplan using a selected automatic layout technique includes:
automatically generating a number of potential desk layouts within the two areas of the digital floorplan; and, and
selecting a most space efficient desk layout of the potential desk layouts as the updated space layout of the office space.

19. The non-transitory computer-readable medium of claim 16, wherein automatically reconfiguring a layout of desks within each of the two areas of the digital floorplan using a selected automatic layout technique includes:
automatically generating a number of potential desk layouts within the two areas of the digital floorplan; and, and
presenting the generated potential desk layouts via the user interface of the space layout system for selection by a user as the updated space layout of the office space.

20. The non-transitory computer-readable medium of claim 16, wherein the selected layout technique includes a brute force automatic layout technique, a rotation automatic layout technique, or a left right automatic layout technique.
